(19) United States
(12) Patent Application Publication
(10) Pub. No.: US 2008/0165220 A1
(43) Pub. Date: Jul. 10, 2008

(54) METHOD AND APPARATUS FOR FORMING IMAGE

(75) Inventors: Masashi Hiroki, Yokohama-shi (JP); Satoshi Kaiho, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/619,721

(22) Filed: Jan. 4, 2007

(51) Int. Cl. B41J 2/165

(52) U.S. Cl. 347/30; 347/29

(57) ABSTRACT

An image forming apparatus includes a carriage on which a recording head of an ink-jet system is mounted, a carriage drive mechanism to drive the carriage, a sheet transport mechanism to transport a sheet in a specified direction, a main power-supply unit, and an auxiliary power-supply unit. The carriage is moved in a direction orthogonal to the transport direction of the sheet by the carriage drive mechanism. The image forming apparatus includes a cap movable in a direction of coming in contact with the recording head and in a direction of separating therefrom, and a cap drive unit to move the cap. The auxiliary power-supply unit supplies electric power to the cap drive unit at a time of interruption of the main power-supply unit.

### BACKGROUND OF THE INVENTION

1. Field of the Invention

The present invention relates to an image forming apparatus for printing an image on a sheet such as, for example, printing paper, and particularly to an image forming apparatus having a recording head of an ink-jet system.

2. Description of the Related Art

An image forming apparatus having a recording head of an ink-jet system includes a head maintenance unit in order to prevent ink attached to a nozzle unit of the recording head from being dried and solidified after the end of printing. In an example of the head maintenance unit, as disclosed in JP-A-2005-161816, a recording head is covered with a cap, so that drying of ink attached to a nozzle unit is prevented. Further, the ink remaining on the nozzle unit is sucked by a suction apparatus, and the nozzle unit is cleaned.

However, in the head maintenance unit of the related art, when power supply is interrupted by some unexpected cause immediately after the end of printing, the cap can not cover the nozzle unit, and the ink attached to the nozzle unit is dried. This causes poor ink discharge of the nozzle unit. Accordingly, when such a situation occurs, it becomes necessary to perform work such that the cleaning of the recording head is forcibly performed or the recording head is replaced. In that case, there is a problem that it takes trouble and cost.

It is an object of the invention to provide an image forming apparatus and an image forming method in which a recording head can be kept in an excellent state.

### BRIEF SUMMARY OF THE INVENTION

According to an aspect of the invention, an image forming apparatus for printing on a sheet by ink discharged from a nozzle unit of a recording head of an ink-jet system includes a carriage on which the recording head is mounted, a carriage drive mechanism including a motor to reciprocate the carriage, a sheet transport mechanism to transport the sheet in a direction orthogonal to a movement direction of the carriage, a cap movable in a direction of coming in contact with the recording head and in a direction of separating therefrom, a head maintenance unit including a cap drive unit to move the cap in the direction of coming in contact with the recording head and in the direction of separating from the recording head, a main power-supply unit to supply electric power to the recording head and the sheet transport mechanism, and an auxiliary power-supply unit to actuate the cap drive unit by supplying electric power to the head maintenance unit at a time of interruption of the main power-supply unit. An example of the auxiliary power-supply unit includes a rechargeable battery.

According to another aspect of the invention, there is provided a switching circuit to switch power supply to the head maintenance unit from the main power-supply unit to the auxiliary power-supply unit at the time of interruption of the main power-supply unit. According to another aspect of the invention, the auxiliary power-supply unit supplies the electric power to the head maintenance unit at a time of operation of the main power-supply unit.

Objects and advantages of the invention will become apparent from the description, which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a perspective view of an image forming apparatus according to a first embodiment of the invention;

FIG. 2 is a side view schematically showing the inside of the image forming apparatus shown in FIG. 1;

FIG. 3 is a perspective view of a carriage drive mechanism and a head maintenance unit of the image forming apparatus shown in FIG. 1;

FIG. 4 is a perspective view of a part of a sheet transport mechanism of the image forming apparatus shown in FIG. 1;

FIG. 5 is a block diagram showing a power-supply unit and a control unit of the image forming apparatus shown in FIG. 1; and

FIG. 6 is a block diagram showing a power-supply unit and a control unit of an image forming apparatus according to a second embodiment of the invention.

### DETAILED DESCRIPTION OF THE INVENTION

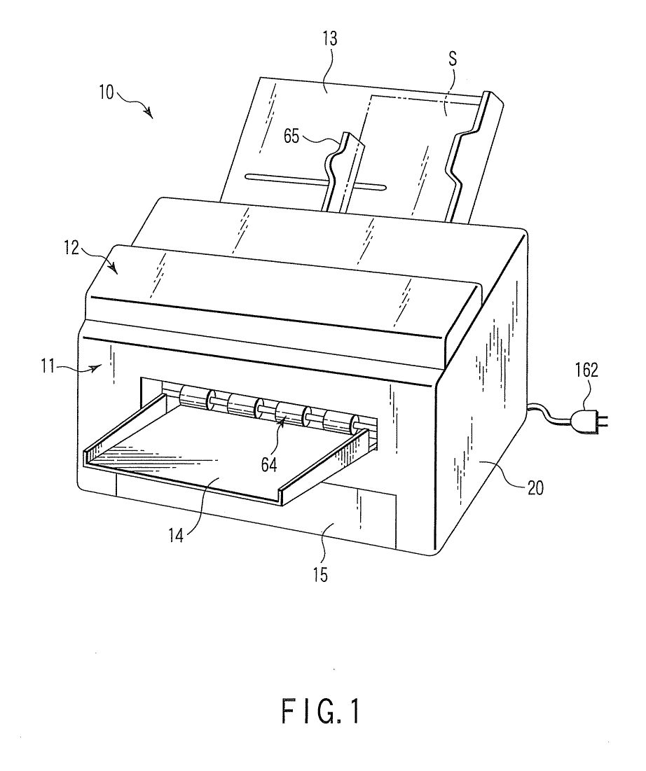

Hereinafter, an image forming apparatus according to a first embodiment of the invention will be described with reference to FIG. 1 to FIG. 5. FIG. 1 shows the outer appearance of an image forming apparatus 10. The image forming apparatus 10 has a function to print an image on a sheet such as, for example, a printing paper. As shown in FIG. 1, the image forming apparatus 10 includes a main body unit 11, a head receiving unit 12 arranged at an upper part of the main body unit 11, a first supply tray 13 arranged at a rear part of the main body unit 11, an ejection tray 14 arranged at a front part of the main body unit 11, a second supply tray 15 received in a lower part of the main body unit 11, and the like.

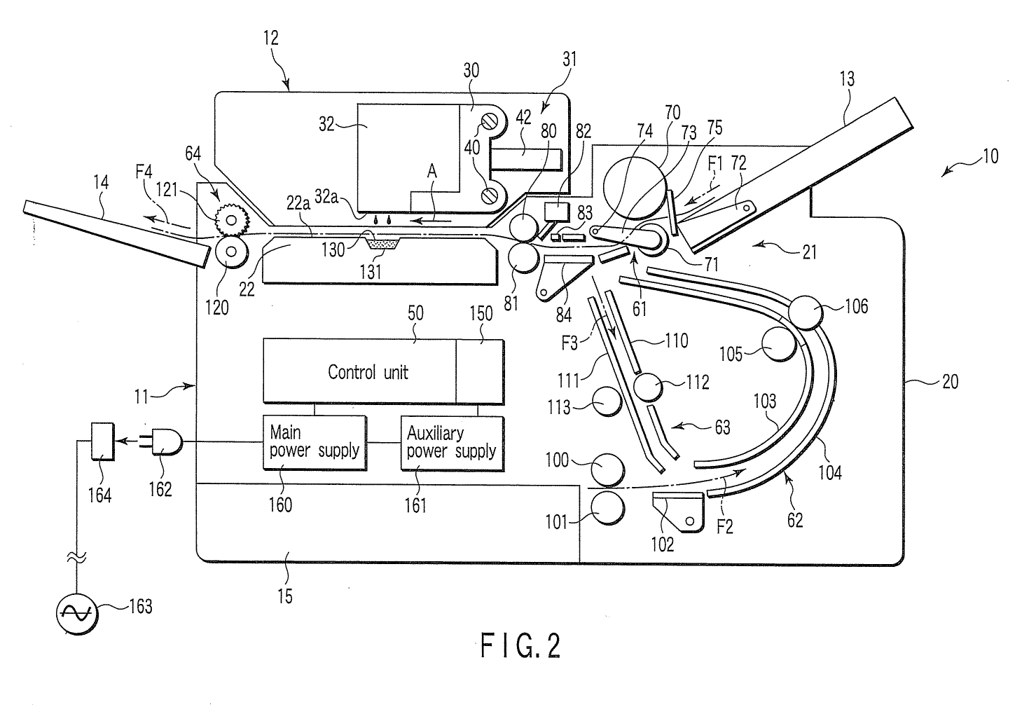

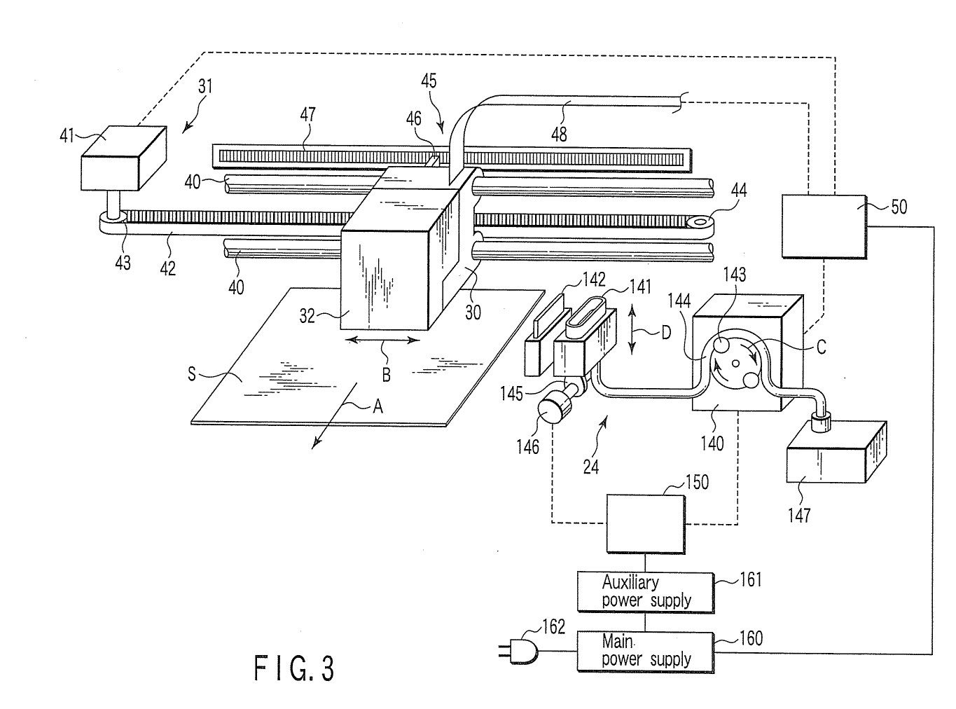

FIG. 2 schematically shows the inside of the image forming apparatus 10. The main body unit 11 includes a housing 20, a sheet transport mechanism 21 constructed inside the housing 20, a sheet guide member 22 having a guide unit 22a in the horizontal direction, a head maintenance unit 24 shown in FIG. 3, and the like. The head maintenance unit 24 will be described later in detail.

A carriage 30, a carriage drive mechanism 31 to drive the carriage 30, a recording head 32 of an ink-jet system mounted on the carriage 30 and the like are arranged in the head receiving unit 12. An exchangeable ink cartridge (not shown) is received in the recording head 32. As shown in FIG. 2, the recording head 32 includes a nozzle unit 32a opening downward to the guide unit 22a of the sheet guide member 22, and an ink discharge mechanism (not shown) to discharge ink from the nozzle unit 32a. The recording head 32 forms an image on a sheet S (shown in FIG. 3) by this ink. An arrow A in FIG. 3 indicates a transport direction of the sheet S.

An example of the ink discharge mechanism includes a thermal type. In the thermal type, heat is applied to ink by a heater incorporated in the recording head 32, so that the ink is film-boiled. A change in pressure occurs in the ink by the growth or contraction of a bubble by this film-boiling. The ink is discharged from the nozzle unit 32a by this change in pressure, so that an image is formed on the sheet S. In addition to the thermal type, an ink discharge mechanism using an element (for example, piezoelectric element) having a piezoelectric effect may be adopted. For example, the piezoelectric element is deformed by an electric current, and ink is discharged from the nozzle unit by the pumping action based on the deformation.

As shown in FIG. 3, the carriage drive mechanism 31 includes a carriage guide 40 extending in the horizontal direction, a motor 41 such as a stepping motor, power transmission members such as a timing belt 42 and sprockets 43 and 44, a sensor unit 45 for controlling the position of the carriage 30, and the like. The carriage guide 40 extends in a direction B orthogonal to the transport direction of the sheet S. The carriage guide 40 is supported by a frame of the head receiving unit 12. The recording head 32, together with the carriage 30, can be reciprocated in the direction (arrow B direction) orthogonal to the transport direction of the sheet S along the carriage guide 40.

The rotation of the motor 41 is transmitted to the carriage 30 through the timing belt 42. Thus, the recording head 32 reciprocates along the carriage guide 40. The sensor unit 45 for controlling the position of the carriage 30 includes, for example, an encoder sensor 46 and a ladder plate 47 as a unit to be detected. The ladder plate 47 extends in the direction parallel to the carriage guide 40. The ladder plate 47 has a ladder pattern formed at an equal pitch. The ladder pattern of the ladder plate 47 is optically detected by the encoder sensor 46 according to the position of the carriage 30, so that the position of the carriage 30 is detected. A signal of the detected position is inputted to a control unit 50 through a flexible harness 48.

The control unit 50 has a function to control the printing operation of the image forming apparatus 10, and includes, for example, a control circuit to control the sheet transport mechanism 21, a control circuit to control the carriage drive mechanism 31, a control circuit to control the ink discharge operation of the recording head 32, and the like.

As shown in FIG. 2, the sheet transport mechanism 21 includes a first transport unit 61, a second transport unit 62, a two-sided printing transport unit 63 used when two-sided printing is performed, an ejection mechanism 64 and the like. The first transport unit 61 transports the sheet taken out from the first supply tray 13 to the recording head 32. The second transport unit 62 transports the sheet taken out from the second supply tray 15 to the recording head 32. The ejection mechanism 64 has a function to eject the printed sheet onto the ejection tray 14.

Plural sheets (for example, printing papers) are stacked in the thickness direction and can be placed on the first supply tray 13. As shown in FIG. 1, a movable guide 65 is provided on the first supply tray 13. The movable guide 65 can be moved in the width direction of the sheet S according to the size of the sheet S. The movable guide 65 is moved in the width direction of the sheet S, so that the position of the sheet S in the width direction on the first supply tray 13 can be regulated.

The first transport unit 61 includes a supply roller 70, a separation roller 71 positioned below the supply roller 70, a separation unit 72 including a separation pad and the like. The supply roller 70 supplies the sheet taken out from the lower end of the first supply tray 13 to the recording head 32. A torque limiter is provided on the separation roller 71.

The separation roller 71 rotates in the same direction as the supply roller 70 by the function of the torque limiter in the case where only one sheet exists between the supply roller 70 and itself. In the case where two or more sheets exist between the supply roller 70 and the separation roller 71, the separation roller 71 rotates in the reverse direction to the supply roller 70. Accordingly, in the case where plural sheets are taken out from the first supply tray 13 and are sent to between the supply roller 70 and the separation roller 71, the sheet at the uppermost part and the other sheets are separated from each other, and only the sheet at the uppermost part is supplied to the recording head 32. The supply roller 70, the separation roller 71, the separation unit 72 and the like constitute a sheet separation mechanism to take out the sheet one by one from the first supply tray 13.

The separation roller 71 is held by a holder 73. The holder 73 can move in the vertical direction around a shaft 74 extending in the horizontal direction. The separation roller 71 is brought into contact with the supply roller 70 at a specified load by a spring and is separated from the supply roller 70 by a not-shown cam. The separation unit 72 can be moved by the not-shown cam in the direction of approaching or separating from the supply roller 70.

The separation roller 71 and the separation unit 72 are respectively separated from the supply roller 70 after the sheet is supplied, are moved to a standby position and are on standby until the time of next sheet supply. A return lever 75 is rotatably arranged in the vicinity of the lower end of the first supply tray 13. The return lever 75 is retracted by a spring to a position where the transport of the sheet is not prevented when the sheet taken out from the first supply tray 13 is transported to the supply roller 70. The return lever 75 is rotated in synchronization with the movement of the separation roller 71 and the separation unit 72 to the standby position, and returns the remaining sheet to the first supply tray 13.

The first transport unit 61 includes a transport roller 80, a pinch roller 81 opposite to the transport roller 80, a sheet sensor 82, a media sensor 83, a switching member 84 and the like. The transport roller 80 supplies the sheet to between the sheet guide member 22 and the recording head 32. The sheet sensor 82 includes a sensor arm capable of detecting the positions of the front end and the rear end of the sheet.

The media sensor 83 has a function to detect the quality (for example, paper quality) or thickness of the sheet. For example, in the case where the surface of the sheet is made of a hygroscopic substance, a signal to increase the amount of ink to be discharged from the recording head 32 is outputted to the control unit 50. In the case where the surface of the sheet is a glossy sheet, for example, a coat paper, control is performed so that a signal to decrease the amount of ink to be discharged from the recording head 32 is outputted to the control unit 50. In the case of color printing, based on a signal from the media sensor 83, a discharge ratio of plural color components may be adjusted.

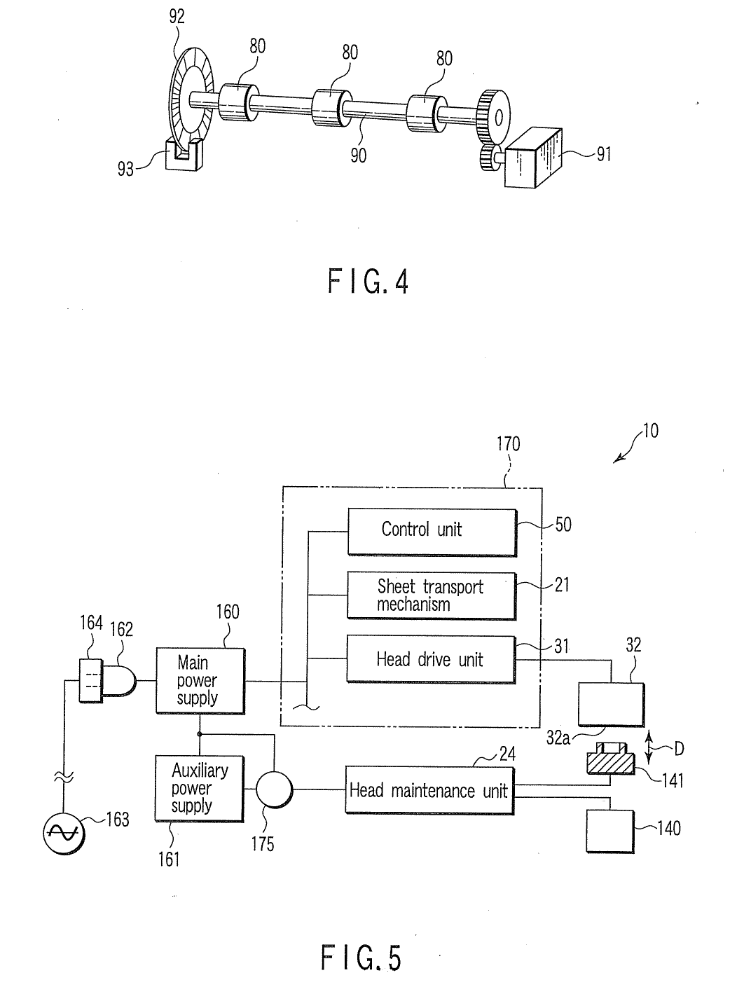

As shown in FIG. 4, the transport roller 80 is attached to a shaft 90. The shaft 90 is rotated by a controllable motor 91 such as a stepping motor. The pinch roller 81 opposite to the transport roller 80 is in contact with the transport roller 80 by a not-shown spring. A disk-like ladder wheel 92 is attached to the shaft 90 of the transport roller 80. A ladder pattern is formed on the ladder wheel 92 in the circumferential direction at a constant pitch. The ladder wheel 92 is detected by the sensor 93, and the input is made to the control unit 50. By this, the rotation of the transport roller 80 is controlled, and the transport of the sheet is controlled at the time of image formation.

The sheet taken out from the first supply tray 13 by the supply roller 70 passes through the first transport unit 61 as indicated by an arrow F1 in FIG. 2 and is transported to between the transport roller 80 and the pinch roller 81. The leading end of the sheet is detected by the sheet sensor 82, and positioning for the image formation is performed. This sheet passes between the upper surface (guide unit 22a) of the sheet guide member 22 and the recording head 32 by the rotation of the transport roller 80. At that time, the image formation is performed on the sheet S by the recording head 32. Ribs functioning as the transport reference surface are formed on the guide unit 22a of the sheet guide member 22. These ribs hold the height of the sheet suitably and prevents the sheet from corrugating. The sheet on which an image has been formed is transported to the ejection mechanism 64.

The second transport unit 62 includes rollers 100 and 101 to take out the sheet from the cassette type second supply tray 15, a switching member 102, guide members 103 and 104 to guide the taken-out sheet, a transport roller 105 provided at the midpoint of the guide members 103 and 104, and a pinch roller 106 opposite to the transport roller 105. The pinch roller 106 is pressed to the transport roller 105 by a spring. Plural sheets (for example, printing papers) are stacked in the thickness direction and can be contained in the second supply tray 15. The rollers 100 and 101 of the second transport unit 62 function as a sheet separation mechanism to take out the sheet one by one from the second supply tray 15.

The sheet taken out from the second supply tray 15 passes through the switching member 102 and passes the guide members 103 and 104 of the second transport unit 62 as indicated by an arrow F2 in FIG. 2. Further, this sheet is transported to the transport roller 80 by the rollers 105 and 106, and is supplied to between the recording head 32 and the sheet guide member 22.

The two-sided printing transport unit 63 includes guide members 110 and 111, a transport roller 112 provided at the midpoint of the guide members 110 and 111, and a pinch roller 113 opposite to the transport roller 112. The pinch roller 113 is pressed to the transport roller 112 by a spring. The guide members 110 and 111 are arranged between the switching member 84 of the first transport unit 61 and the switching member 102 of the second transport unit 62. At the time of two-sided printing, the sheet is made to pass in an arrow F3 direction in FIG. 2. The transport rollers 80, 105 and 112 are such that a rubber resin such as EPDM (ethylene propylene diene rubber) is provided on a metal shaft, and has a function to transport the sheet S by friction.

In the case where the two-sided printing is performed, after one side of a sheet is printed by the recording head 32, the rear end of this sheet is detected by the sheet sensor 82. Immediately after that, the transport roller 80 is reversely rotated, and the position of the switching member 84 is switched. By this, the sheet is sent to the two-sided printing transport unit 63 as indicated by the arrow F3 in FIG. 2. Further, this sheet is transported by the rollers 112 and 113, passes through the switching member 102, and passes the guide members 103 and 104 of the second transport unit 62. In this way, the sheet turns over, and this sheet is again sent to the recording head 32 by the transport roller 80, so that the other side of the sheet is printed.

The ejection mechanism 64 includes an ejection roller 120, a star wheel 121, a transmission mechanism (not shown) to transmit the rotation of the transport roller 80 to the ejection roller 120 and the star wheel 121, and the like. The star wheel 121 is a gear-like wheel made of a thin plate of stainless steel or the like. The sheet printed by the recording head 32 is pressed to the ejection roller 120 by the star wheel 121 and is transported in a direction indicated by an arrow F4 toward the ejection tray 14. The star wheel 121 prevents the sheet after printing from rising from the ejection roller 120.

As shown in FIG. 2, an ink absorption unit 130 is formed on the upper side of the sheet guide member 22. The ink absorption unit 130 is opposite to the nozzle unit 32a of the recording head 32, and is formed at a position lower than the guide unit 22a. The width of the ink absorption unit 130 is larger than the width of the sheet S. The ink absorption unit 130 contains, for example, a sponge-like ink absorption member 131. In the case where frameless printing of a sheet is performed, surplus ink protruding from the edge of the sheet is absorbed by this ink absorption member 131, so that it is prevented that a subsequent sheet is soiled.

The head maintenance unit 24 shown in FIG. 3 includes a suction device 140 for cleaning the recording head 32, a cap 141 for preventing drying of the recording head 32, a blade member 142 for cleaning the nozzle unit 32a of the recording head 32, and the like. In an example of the suction device 140, a tube 144 is squeezed in a direction indicated by an arrow C by a rotator 143, so that a negative pressure is generated inside the cap 141.

The cap 141 can be moved in the vertical direction (an arrow D direction in FIG. 3) by a cap drive unit 145. In the cap drive unit 145, for example, an actuator 146 such as, for example, a solenoid is used as a drive source, and the cap 141 is moved up and down. A waste ink tank 147 is connected to the suction device 140. Incidentally, the rotation of the motor is converted into a linear movement by a cam or a link mechanism, and the cap 141 may be moved up and down. At the time of maintenance, in order to remove foreign matter attached to the nozzle unit 32a, a small amount of ink may be discharged from the nozzle unit 32a. The suction device 140 and the cap drive unit 145 are controlled by a maintenance control unit 150. The maintenance control unit 150 forms a part of the head maintenance unit 24.

This image forming apparatus 10 includes a main power-supply unit 160 and an auxiliary power-supply unit 161. The main power-supply unit 160 is connected to a socket 164 of a commercial power supply 163 through a power-supply plug 162. The main power supply in the embodiment is the power supply supplied from the commercial power supply 163. AC electric power is supplied to the main power-supply unit 160 from the commercial power supply 163.

The main power-supply unit 160 includes a transformer to convert the AC voltage from the commercial power supply 163 to a specified voltage, a rectifier to convert AC to DC, and the like. The main power-supply unit 160 can supply DC electric power to the auxiliary power-supply unit 161. The auxiliary power-supply unit 161 includes a rechargeable battery capable of rapid charging, that is, a secondary battery. This rechargeable battery is always in a full charged state by the electric power supplied from the main power-supply unit 160. The auxiliary power-supply unit 161 supplies the DC electric power to the head maintenance unit 24. Incidentally, in the case the timing when the auxiliary power-supply unit 161 is charged is made one other than the time of image formation or the time of printing operation, it is possible to suppress that the peak of electric power consumption becomes excessively high.

As shown in FIG. 5, the main power-supply unit 160 is connected to a main unit 170 of the image forming apparatus 10. The main unit 170 includes main components relating to the printing operation, such as the sheet transport mechanism 21, the carriage drive mechanism 31, the ink discharge mechanism of the recording head 32, and the control unit 50. Besides, the main power-supply unit 160 is connected also to the head maintenance unit 24 through a switching circuit 175. Accordingly, at the time of operation of the main power-supply unit 160, electric power is outputted to the main unit 170 and the head maintenance unit 24 from the main power-supply unit 160. The auxiliary power-supply unit 161 is connected to the head maintenance unit 24 through the switching circuit 175. The auxiliary power-supply unit 161 can output DC electric power to the head maintenance unit 24.

In this embodiment, the electric power is supplied from the commercial power supply 163 to the main power-supply unit 160, and the electric power outputted from the main power-supply unit 160 is supplied to the main unit 170 of the image forming apparatus 10 and the head maintenance unit 24. Accordingly, this image forming apparatus 10 can perform a desired printing operation at the time of operation of the main power-supply unit 160 by the electric power supplied from the commercial power supply 163. Further, at the time of operation of the main power-supply unit 160, the head maintenance unit 24 can also function. On the other hand, the auxiliary power-supply unit 161 supplies the electric power to the head maintenance unit 24 only when the main power supply is interrupted.

At the time of head maintenance, the recording head 32 is moved to a specified maintenance position by the carriage drive mechanism 31. Thereafter, the cap 141 is raised to the recording head 32 by the cap drive unit 145, and the cap 141 is brought into close contact with the recording head 32. The cap 141 covers the nozzle unit 32a. By this, it is prevented that remaining ink attached to the nozzle unit 32a is dried. In this state, the suction device 140 is actuated to generate a negative pressure inside the cap 141, so that the remaining ink attached to the nozzle unit 32a is sucked. The sucked waste ink is ejected into the waste ink tank 147. Thereafter, the cap 141 is separated from the recording head 32, and further, the nozzle unit 32a is cleaned by the blade member 142.

It is conceivable that immediately after printing, the main power supply is interrupted by some cause. For example, it is assumed that before the nozzle unit 32a is cleaned, the power supply plug 162 falls out from the socket 164, and the main power supply is interrupted. In that case, instead of the main power-supply unit 160, the auxiliary power-supply unit 161 functions. That is, the electric power charged in the auxiliary power-supply unit 161 is supplied to the head maintenance unit 24.

The maintenance control unit 150 controls the carriage drive mechanism 31 so that the recording head 32 moves to the specified maintenance position. At that time, the auxiliary power-supply unit 161 supplies the electric power to the carriage drive mechanism 31. Besides, the auxiliary power-supply unit 161 supplies the electric power to the cap drive unit 145. Thus, the cap 141 moves in the direction of coming in contact with the recording head 32, so that the nozzle unit 32a is covered with the cap 141.

Besides, the suction device 140 is actuated by the electric power supplied from the auxiliary power-supply unit 161, and the remaining ink attached to the nozzle unit 32a is sucked. Further, the nozzle unit 32a of the recording head 32 is cleaned by the blade member 142. After the maintenance operations are ended, the electric power supply from the auxiliary power-supply unit 161 to the head maintenance unit 24 is stopped.

As described above, according to the first embodiment, even if the main power supply is interrupted by some cause, the head maintenance unit 24 can perform the specified maintenance function. Accordingly, the nozzle unit 32a of the recording head 32 can always keep the clean state, and the nozzle unit 32a can maintain the excellent ink discharge state.

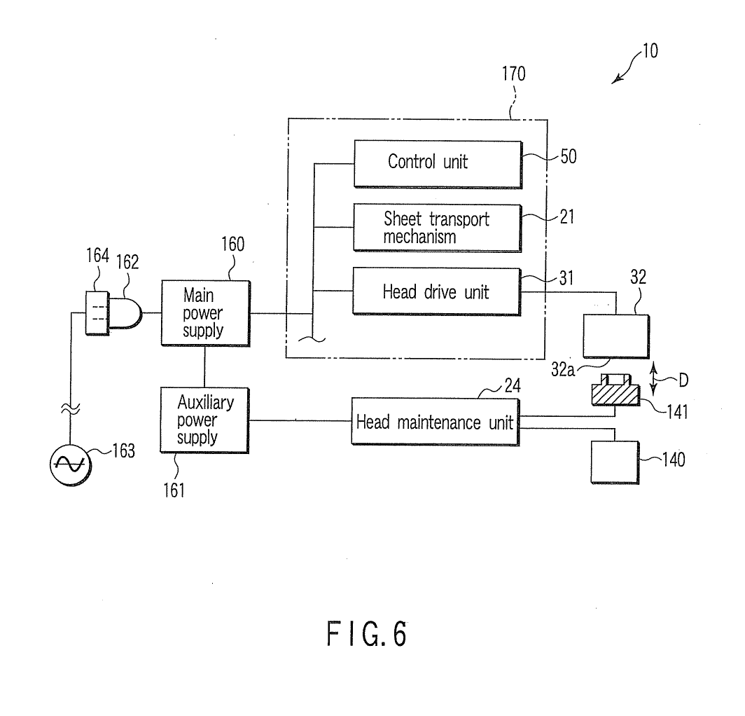

FIG. 6 shows a second embodiment. In the second embodiment, a main power-supply unit 160 supplies electric power to a main unit 170 of an image forming apparatus 10 and an auxiliary power-supply unit 161. The auxiliary power-supply unit 161 supplies electric power to a head maintenance unit 24. That is, the auxiliary power-supply unit 161 supplies the electric power to the head maintenance unit 24 at both the operation time of the main power-supply unit 160 and the interruption time thereof. Thus, according to the second embodiment, the switching circuit 175 of the first embodiment can be omitted, and there is a merit that the circuit structure can be simplified. With respect to the structure and function other than that, the second embodiment is similar to the first embodiment.

Next, a third embodiment will be described. An auxiliary power-supply unit 161 of the third embodiment supplies electric power to a cap drive unit 145 until a cap 141 comes in close contact with a recording head 32 in maintenance operations of a head maintenance unit 24. The maintenance operations of a suction device 140 and a blade member 142 are performed by electric power supplied from a main power-supply unit 160. Other than that, this embodiment is similar to the first embodiment or the second embodiment. Also in the third embodiment, it is possible to prevent the remaining ink of a nozzle unit 32a from being dried at the time of interruption of the main power-supply unit 160.

In a fourth embodiment, as an auxiliary power-supply unit 161, a non-rechargeable battery, that is, a primary battery such as an exchangeable dry battery is used. By this auxiliary power-supply unit 161, electric power is supplied to a head maintenance unit 24 at the time of interruption of a main power-supply unit 160. Since the structure and function other than that are similar to any one of the first to the third embodiments, their description will be omitted.

As described above, the foregoing respective embodiments include the following steps.

Transporting the sheet S in the specified direction by the sheet transport mechanism 21. Moving the recording head 32 in the direction orthogonal to the transport direction of the sheet S by the carriage drive mechanism 31. Forming the image on the sheet S by discharging ink from the recording head 32 to the sheet S. Covering the nozzle unit 32a of the recording head 32 with the cap 141 by actuating the head maintenance unit 24 by electric power supplied from the auxiliary power-supply unit 161 at the time of interruption of the main power supply. These steps are carried out based on the computer program stored in the control unit 50 and the maintenance control unit 150.

According to the foregoing respective embodiments, even if the main power-supply unit 160 loses the function by some cause, it is possible to prevent the remaining ink of the nozzle unit 32a from being dried, and poor discharge of ink can be prevented. Thus, the recording head 32 is kept in an excellent state.

Incidentally, the invention can also be applied to an image forming apparatus for printing on a sheet other than the printing paper, for example, paper of various forms, or a sheet made of cloth, plastic or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An image forming apparatus for printing on a sheet by ink discharged from a nozzle unit of a recording head of an ink-jet system, comprising:
a carriage on which the recording head is mounted;
a carriage drive mechanism including a motor to reciprocate the carriage;
a sheet transport mechanism to transport the sheet in a direction orthogonal to a movement direction of the carriage;
a cap movable in a direction of coming in contact with the recording head and in a direction of separating therefrom;
a head maintenance unit including a cap drive unit to move the cap in the direction of coming in contact with the recording head and in the direction of separating from the recording head;
a main power-supply unit to supply electric power to the recording head and the sheet transport mechanism; and
an auxiliary power-supply unit to actuate the cap drive unit by supplying electric power to the head maintenance unit at a time of interruption of the main power-supply unit.

2. The image forming apparatus according to claim 1, wherein the head maintenance unit includes a suction device to suck remaining ink attached to the nozzle unit of the recording head, and the auxiliary power-supply unit supplies the electric power to the cap drive unit and the suction device at the time of interruption of the main power-supply unit.

3. The image forming apparatus according to claim 1, further comprising a switching circuit to switch power supply to the head maintenance unit from the main power-supply unit to the auxiliary power-supply unit at the time of interruption of the main power-supply unit.

4. The image forming apparatus according to claim 2, further comprising a switching circuit to switch power supply to the head maintenance unit from the main power-supply unit to the auxiliary power-supply unit at the time of interruption of the main power-supply unit.

5. The image forming apparatus according to claim 1, wherein the auxiliary power-supply unit supplies the electric power to the head maintenance unit at a time of operation of the main power-supply unit and at the time of interruption thereof.

6. The image forming apparatus according to claim 2, wherein the auxiliary power-supply unit supplies the electric power to the head maintenance unit at a time of operation of the main power-supply unit and at the time of interruption thereof.

7. The image forming apparatus according to claim 1, wherein the auxiliary power-supply unit includes a rechargeable battery.

8. The image forming apparatus according to claim 2, wherein the auxiliary power-supply unit includes a rechargeable battery.

9. The image forming apparatus according to claim 1, wherein the auxiliary power-supply unit supplies the electric power to the carriage drive mechanism to move the recording head to a maintenance position at the time of interruption of the main power-supply unit.

10. The image forming apparatus according to claim 2, wherein the auxiliary power-supply unit supplies the electric power to the carriage drive mechanism to move the recording head to a maintenance position at the time of interruption of the main power-supply unit.

11. An image forming apparatus for printing on a sheet by ink discharged from a nozzle unit of a recording head of an ink-jet system, comprising:
sheet transport means for transporting the sheet in a specified direction;
carriage drive means for moving a carriage on which the recording head is mounted in a direction orthogonal to the transport direction of the sheet;
means for forming an image on the sheet by discharging the ink to the sheet from the nozzle unit;
cap means movable in a direction of coming in contact with the recording head and in a direction of separating therefrom;
cap drive means for moving the cap means in the direction of coming in contact with the recording head and in the direction of separating from the recording head;
main power-supply means for supplying electric power to the recording head and the sheet transport means; and
auxiliary power-supply means for actuating the cap drive means by supplying electric power to the cap drive means at a time of interruption of the main power-supply means.

12. An image forming method for printing on a sheet by ink discharged from a nozzle unit of a recording head of an ink-jet system, comprising:
transporting the sheet in a specified direction by actuating a sheet transport mechanism by electric power supplied from a main power-supply unit;
moving the recording head in a direction orthogonal to the transport direction of the sheet by actuating carriage drive means by the electric power supplied from the main power-supply unit;
forming an image on the sheet by actuating an ink discharge mechanism of the recording head by the electric power supplied from the main power-supply unit and by discharging the ink from the nozzle unit; and
moving a cap to the recording head to cover the nozzle unit with the cap by supplying electric power from an auxiliary power-supply unit to a head maintenance unit at a time of interruption of the main power-supply unit.

13. The image forming method according to claim 12, wherein at a time of operation of the main power-supply unit, the electric power outputted from the main power-supply unit is supplied to the head maintenance unit, and at the time of interruption of the main power-supply unit, instead of the main power-supply unit, the electric power outputted from the auxiliary power-supply unit is supplied to the head maintenance unit.

14. The image forming apparatus according to claim 12, wherein at a time of operation of the main power-supply unit, the electric power outputted from the auxiliary power-supply unit is supplied to the head maintenance unit, and also at the time of interruption of the main power-supply unit, the electric power outputted from the auxiliary power-supply unit is supplied to the head maintenance unit.
